(19) United States
(12) Patent Application Publication
(10) Pub. No.: US 2012/0004020 A1
(43) Pub. Date: Jan. 5, 2012

(54) GAMING SYSTEM AND METHOD

(76) Inventor: Alexander Sandford Todd Young, Randwick NSW (AU)

(21) Appl. No.: 13/174,026

(22) Filed: Jun. 30, 2011

(30) Foreign Application Priority Data
Jun. 30, 2010 (AU) 2010902919

(51) Int. Cl. A63F 13/00

(52) U.S. Cl. 463/20

(57) ABSTRACT

A method of controlling output of a game outcome to a player in a gaming system: obtaining a stop position for each of a plurality of reels, each reel having a plurality of symbols, each stop position specifying which symbols of the reel will be displayed to thereby specify a game outcome; determining whether an output selection condition is met in respect of the specified game outcome; randomly selecting from at least two different outputs of the specified game outcome based on probabilities associated with respective ones of the at least two different outputs upon the output selection condition being met; outputting the specified game outcome in accordance with the selected output.

### RELATED APPLICATIONS

This application claims priority to Australian Patent Application No. 2010902919 having a filing date of Jun. 30, 2010, which is incorporated herein by reference in its entirety.

### BACKGROUND OF THE INVENTION

The present invention relates to a gaming system, a gaming method, and a game controller and a player interface.

Australian patent 603193 discloses a poker machine having a means to cause each reel to turn to a stop in a position where a single line of symbols (one for each reel) is exhibited behind a viewing window. The poker machine has means for determining the length of time for which each reel is spun. If the same symbol is exhibited by a plurality of first stopped reels, normal operation of the machine is suspended and the time for which the next reel is spun is extended by a defined amount.

While such a gaming machine has provided enjoyment, there is a need for alternative gaming systems.

### BRIEF SUMMARY OF THE INVENTION

In a first aspect, the invention provides a method of controlling output of a game outcome to a player in a gaming system:

obtaining a stop position for each of a plurality of reels, each reel having a plurality of symbols, each stop position specifying which symbols of the reel will be displayed to thereby specify a game outcome;

determining whether an output selection condition is met in respect of the specified game outcome;
randomly selecting from at least two different outputs of the specified game outcome based on probabilities associated with respective ones of the at least two different outputs upon the output selection condition being met;
outputting the specified game outcome in accordance with the selected output.

In an embodiment, determining that an output selection condition is met comprises determining whether the to be displayed symbols of a first subset of the plurality of reels, each of which will be spun to a stop prior to at least one other reel of the plurality of reels, include at least part of a designated winning symbol combination.

In an embodiment, there are a plurality of designated winning symbol combinations and the method comprises determining that the to be displayed symbols of a first subset include at least one of the designated winning symbol combinations.

In an embodiment, the plurality of designated winning symbol combinations are formed from different numbers of the same designated symbol.

In an embodiment, the method comprises assigning first probabilities to the at least two different outputs upon the first subset including a first number of the designated symbol and assigning second probabilities to the at least two different outputs upon the first subset including a second number of the designated symbol winning combination.

In an embodiment, the method comprises assigning first probabilities to the at least two different outputs upon the first subset including part of the designated winning symbol combination and assigning second probabilities to the at least two different outputs upon the first subset including all of the winning combination.

In an embodiment, there are a plurality of possible game outcomes and a subset of the game outcomes meet the output selection condition.

In an embodiment, each output includes at least one modification relative to the output of reels being spun to a stop when the output selection condition is not met.

In an embodiment, there are three different outputs corresponding to three different modifications and a first modification comprises an alternative sound, a second modification comprises an extended reel spin and an alternative sound, and a third modification comprises an extra-extended reel spin and an alternative sound.

In an embodiment, the third modification can only occur when the specified game outcome includes the player triggering a feature game.

In an embodiment, determining whether an output selection condition is met in respect of the specified game outcome is partly based on a wager placed by a player.

In a second aspect, the invention provides a gaming system comprising:

a stop determiner configured to determine a stop position of a each of a plurality of reels, each reel having a plurality of symbols, each stop position specifying which symbols of the reel will be displayed to thereby specify a game outcome;

a player interface for outputting the game outcome to a player and including a display for displaying spinning of each reel to the reel's stop position; and

an output controller arranged to:
determine whether an output selection condition is met in respect of the specified game outcome;
randomly select from at least two different outputs of the specified game outcome based on probabilities associated with respective ones of the at least two different outputs upon the output selection condition being met; and
control output of the specified game outcome with the player interface in accordance with the selected output.

In an embodiment, the player interface includes at least one speaker, and one or more of the outputs includes sound for output with the at least one speaker.

In an embodiment, the output controller determines that an output selection condition is met by determining whether the to be displayed symbols of a first subset of the plurality of reels, each of which will be spun to a stop prior to at least one other reel of the plurality of reels, include at least part of a designated winning symbol combination.

In an embodiment, there are a plurality of designated winning symbol combinations and the output controller determines that the to be displayed symbols of a first subset include at least one of the designated winning symbol combinations.

In an embodiment, the plurality of designated winning symbol combinations are formed from different numbers of the same designated symbol.

In an embodiment, the output controller assigns first probabilities to the at least two different outputs upon the first subset including a first number of the designated symbol and assigns second probabilities to the at least two different outputs upon the first subset including a second number of the designated symbol winning combination.

In an embodiment, the output controller assigns first probabilities to the at least two different outputs upon the first subset including part of the designated winning symbol combination and assigns second probabilities to the at least two different outputs upon the first subset including all of the winning combination.

In an embodiment, there are a plurality of possible game outcomes and a subset of the game outcomes meet the output selection condition.

In an embodiment, each output includes at least one modification relative to the output of reels being spun to a stop when the output selection condition is not met.

In an embodiment, there are three different outputs corresponding to three different modifications and a first modification comprises an alternative sound, a second modification comprises an extended reel spin and an alternative sound, and a third modification comprises an extra-extended reel spin and an alternative sound.

In an embodiment, the output controller is arranged such that the third modification can only occur when the specified game outcome includes the player triggering a feature game.

In an embodiment, determining whether an output selection condition is met in respect of the specified game outcome is partly based on a wager placed by a player.

In a third aspect, the invention provides a game controller for a gaming system, the game controller arranged to:

determine a stop position of a each of a plurality of reels, each reel having a plurality of symbols, each stop position specifying which symbols of the reel will be displayed to thereby specify a game outcome;

determine whether an output selection condition is met in respect of the specified game outcome;
randomly select from at least two different outputs of the specified game outcome based on probabilities associated with respective ones of the at least two different outputs upon the output selection condition being met; and
control output of the specified game outcome in accordance with the selected output.

In an embodiment, the game controller is arranged to determine that an output selection condition is met by determining whether the to be displayed symbols of a first subset of the plurality of reels, each of which will be spun to a stop prior to at least one other reel of the plurality of reels, include at least part of a designated winning symbol combination.

In an embodiment, there are a plurality of designated winning symbol combinations and the game controller determines that the to be displayed symbols of a first subset include at least one of the designated winning symbol combinations.

In an embodiment, the plurality of designated winning symbol combinations are formed from different numbers of the same designated symbol.

In an embodiment, the game controller is arranged to assign first probabilities to the at least two different outputs upon the first subset including a first number of the designated symbol and assign second probabilities to the at least two different outputs upon the first subset including a second number of the designated symbol winning combination.

In an embodiment, the game controller is arranged to assign first probabilities to the at least two different outputs upon the first subset including part of the designated winning symbol combination and assign second probabilities to the at least two different outputs upon the first subset including all of the winning combination.

In an embodiment, there are a plurality of possible game outcomes and a subset of the game outcomes meet the output selection condition.

In an embodiment, each output includes at least one modification relative to the output of reels being spun to a stop when the output selection condition is not met.

In an embodiment, there are three different outputs corresponding to three different modifications and a first modification comprises an alternative sound, a second modification comprises an extended reel spin and an alternative sound, and a third modification comprises an extra-extended reel spin and an alternative sound.

In an embodiment, the game controller is arranged such that third modification can only occur when the specified game outcome includes the player triggering a feature game.

In an embodiment, determining whether an output selection condition is met in respect of the specified game outcome is partly based on a wager placed by a player.

In a fourth aspect, the invention provides a gaming system comprising:
a stop determiner configured to determine a stop position of a each of a plurality of reels, each reel having a plurality of symbols, each stop position specifying which symbols of the reel will be displayed to thereby specify a game outcome;
a player interface for outputting the game outcome to a player and including a display for displaying spinning of each reel to the reel's stop position; and
an output controller arranged to:
   determine whether an output selection condition is met in respect of the specified game outcome;
   randomly select from at least two different outputs of the specified game outcome based on probabilities associated with respective ones of the at least two different outputs upon the output selection condition being met; and
   control output of the specified game outcome with the player interface in accordance with the selected output.

In a fifth aspect, the invention provides a gaming system comprising:
means for determining a stop position of a each of a plurality of reels, each reel having a plurality of symbols, each stop position specifying which symbols of the reel will be displayed to thereby specify a game outcome;
means for outputting the game outcome to a player and including a display for displaying spinning of each reel to the reel's stop position;
means for determining whether an output selection condition is met in respect of the specified game outcome;
means for randomly select from at least two different outputs of the specified game outcome based on probabilities associated with respective ones of the at least two different outputs upon the output selection condition being met; and
means for controlling output of the specified game outcome in accordance with the selected output.

In a sixth aspect, the invention provides a gaming machine comprising:
a cabinet;
a display mounted to the cabinet for displaying game outcomes to a player;
a speaker mounted to or within the cabinet;
at least one input device operable to initiate a play of a game; and
a game controller mounted within the cabinet and communicatively coupled to each of the display, the speaker and the at least one input device and operable responsive to operation of the at least one input device to conduct a play of a game in part by obtaining a stop position for each of a plurality of reels, each reel having a plurality of symbols, each stop position specifying which symbols of the reel will be displayed to thereby specify a game outcome, determining whether an output selection condition is met in respect of the specified game outcome, randomly selecting from at least two different outputs of the specified game outcome based on probabilities associated with respective ones of the at least two different outputs upon the output selection condition being met, and controlling the display and the speaker to output the specified game outcome in accordance with the selected output.

In a seventh aspect, the invention provides computer program code which when executed implements the above method.

In an eighth aspect, the invention provides a tangible computer readable medium comprising the above program code.

In a ninth aspect, the invention extends to transmitting the above program code.

### BRIEF DESCRIPTION OF SEVERAL VIEWS OF THE DRAWINGS

FIG. 1 is a perspective view of a stand alone gaming machine;

FIG. 2 is a block diagram of the functional components of a gaming machine;

FIG. 3 is a schematic diagram of the functional components of a memory;

FIG. 4 is a schematic diagram of a network gaming system;

FIG. 5 is an exemplary display during a game in accordance with the example;

FIG. 6 is a block diagram of the gaming system according to the preferred embodiment; and

FIG. 7 is a flowchart showing the method of the preferred embodiment.

### DETAILED DESCRIPTION OF THE INVENTION

Referring to the drawings, there is shown a gaming system having a game controller arranged to implement a method of gaming where certain game outcomes can be output to the player in more than one way. The method involves determining whether an output condition is met by a game outcome such that it is necessary to select between two or more outputs and then selecting between the outputs of the game outcome in accordance with probabilities assigned to the outputs. In the embodiment, each output includes some modification to the normal manner in which game outcomes are output such as modified accompanying sounds or a modified display. In the embodiment, the output condition is that a first part of the game outcome to be presented to the player contains at least part of a winning combination of symbols. Thus, an advantage of the embodiment is game outcomes with part of a winning outcome will not always be output the same way so as to provide variation to the player to enable the player to anticipate a winning outcome without finding the accompanying output tedious.

### General Construction of Gaming System

The gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

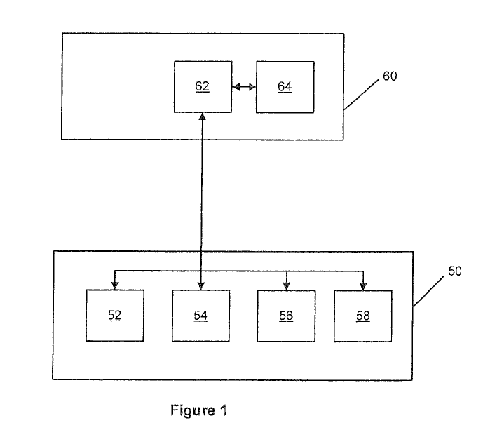

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions to play the game and observe the game outcomes.

Components of the player interface may vary from embodiment to embodiment but will typically include a credit mechanism 52 to enable a player to input credits and receive payouts, one or more displays 54, a game play mechanism 56 including one or more input devices that enable a player to input game play instructions (e.g. to place a wager), and one or more speakers 58.

The game controller 60 is in data communication with the player interface and typically includes a processor 62 that processes the game play instructions in accordance with game play rules and outputs game play outcomes to the display. Typically, the game play rules are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor using an application specific integrated circuit (ASIC) or a field programmable gate array (FPGA).

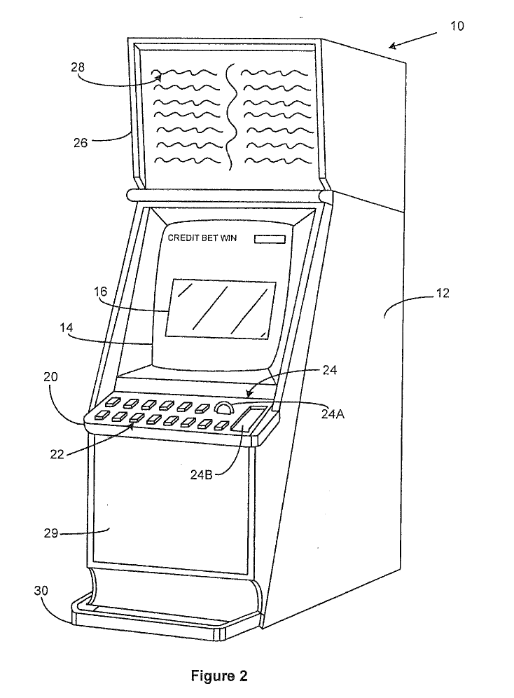

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may configure for ticket in such that they have a ticket reader for reading tickets having a value and crediting the player based on the face value of the ticker. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

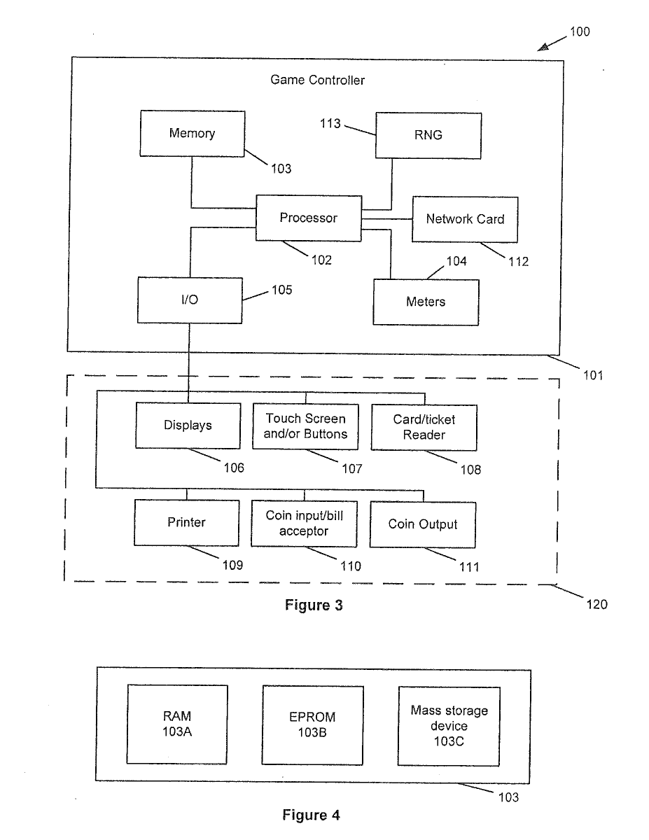

FIG. 3 shows a block diagram of operative components of a typical gaming machine which may be the same as or different to the gaming machine of FIG. 2.

The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game.

In addition, the gaming machine 100 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—i.e. the player marketing module may be in data communication with one or more of the above devices and communicate with it on behalf of the gaming machine.

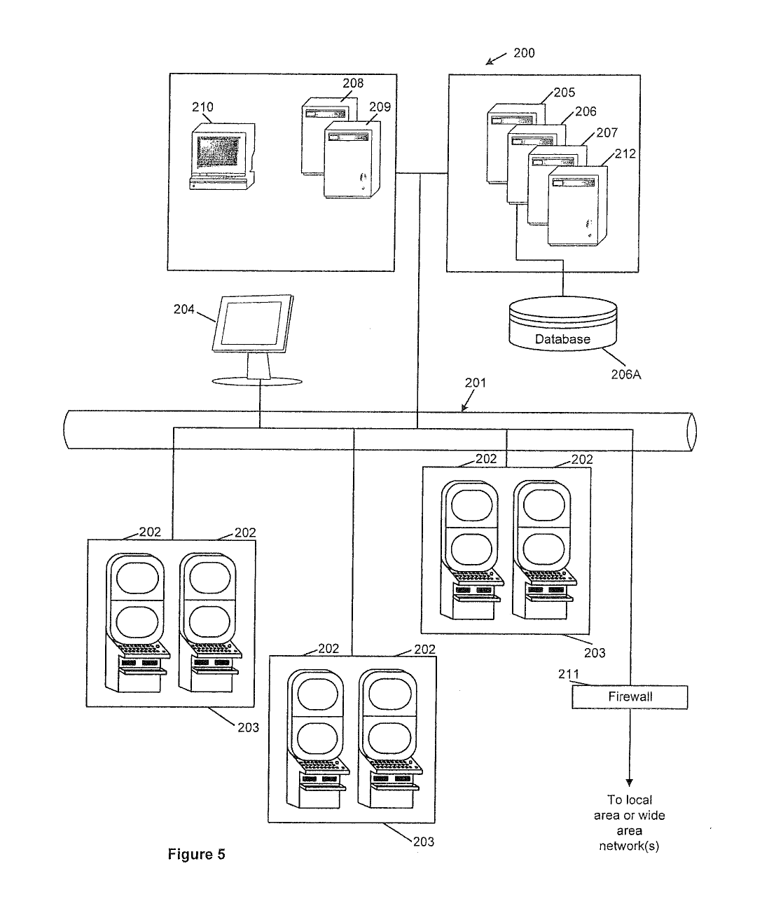

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 1038 or elsewhere.

It is also possible for the operative components of the gaming machine 100 to be distributed, for example input/output devices 106,107,108,109,110,111 to be provided remotely from the game controller 101.

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games as required by the terminals.

### Further Detail of Gaming System

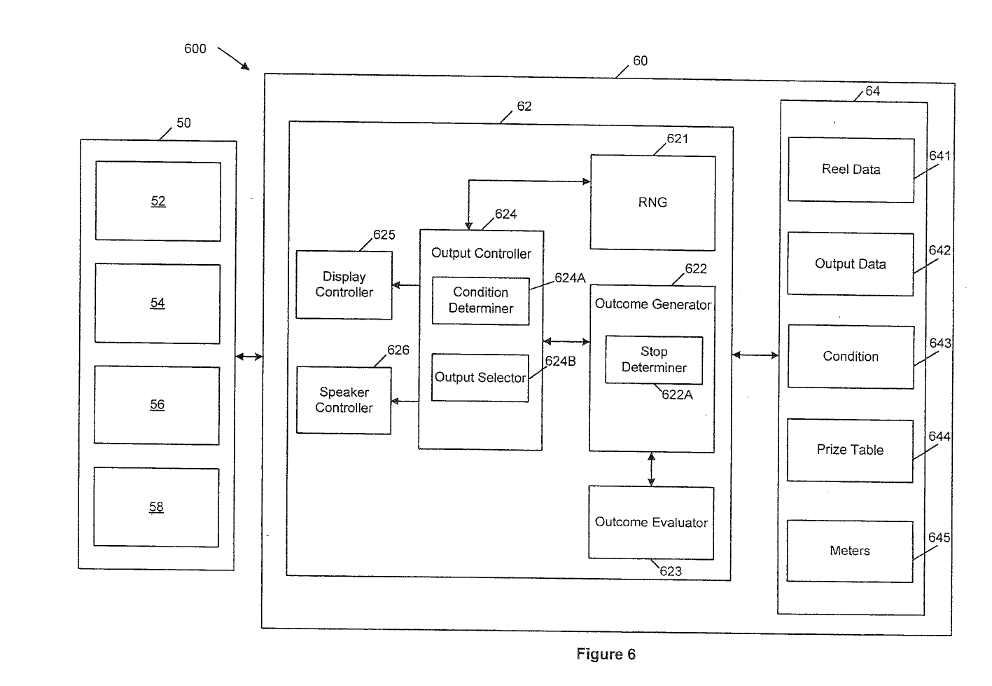

Referring to FIG. 6, the gaming system 600 is arranged for the player to play a spinning reel game. The player operates the game play mechanism 56 to specify a wager and hence the win entitlement which will be evaluated for this play of the game and initiates a play of the game. Persons skilled in the art will appreciate that a player's win entitlement will vary from game to game dependent on player selections. In most spinning reel games, it is typical for the player's entitlement to be affected by the amount they wager and selections they make (i.e. the nature of the wager). For example, a player's win entitlement may be based on how many lines they play in each game—e.g. a minimum of one line up to the maximum number of lines allowed by the game (noting that not all permutations of win lines may be available for selection) and how much they wager per line. Such win lines are typically formed by a combination of symbol display positions, one from each reel, the symbol display positions being located relative to one another such that they form a line.

In many games, the player's win entitlement is not strictly limited to the lines they have selected, for example, “scatter” pays are awarded independently of a player's selection of pay lines and are an inherent part of the win entitlement.

Persons skilled in the art, will appreciate that in other embodiments, the player may obtain a win entitlement by selecting a number of reels to play and an amount to wager per reel. Such games are marketed under the trade name “Reel Power” by Aristocrat Leisure Industries Pty Ltd. The selection of the reel means that each displayed symbol of the reel can be substituted for a symbol at one or more designated display positions. In other words, all symbols displayed at symbol display positions corresponding to a selected reel can be used to form symbol combinations with symbols displayed at a designated, symbol display positions of the other reels. For example, if there are five reels and three symbol display positions for each reel such that the symbol display positions comprise three rows of five symbol display positions, the symbols displayed in the centre row are used for non-selected reels. As a result, the total number of ways to win is determined by multiplying the number of active display positions of each reels, the active display positions being all display positions of each selected reel and the designated display position of the non-selected reels. As a result for five reels and fifteen display positions there are 243 ways to win.

In FIG. 6, the processor 62 of game controller 60 is shown implementing a number of modules based on program code and data stored in memory 64. Persons skilled in the art will appreciate that various of the modules could be implemented in some other way, for example by a dedicated circuit. These modules include the outcome generator 622 which operates in response to the player's operation of game play mechanism 56 to place the wager and initiate a play of the game so as to generate a game outcome which will then be evaluated by award evaluator 623.

The game outcome is formed by selecting which symbols will be displayed. One example of selecting symbols is for the stop determiner 622A selects symbols for display from a plurality of symbol sets corresponding to respective ones of a plurality of spinning reels and stored as reel data. The data for each reel specifies a sequence of symbols for each reel (sometimes known as a “reel strip”) such that the stop determiner 622A can select all of the symbols for display by selecting a stopping position in the sequence which correspond to a designated display position on the display. In one example, three symbols of each of five reels may be displayed such that symbols are displayed at fifteen display positions on display 54. It is known to use a probability table stored in memory 64 to vary the odds of a particular stop position being selected. Other techniques can be used to control the odds of particular outcomes occurring to thereby control the return to player of the game.

As is conventional in such spinning reel games, the gaming system is arranged such that the reels spin before the symbols are displayed. In the embodiment, where a video display 54 is used, this will result in a display where the reel is animated so that initially the reel is imperceptible to give the impression of spinning and then the symbols become perceptible so that a certain number of symbols (for example 6 symbols) can be viewed by the player before the reel reaches the stop position. (In a mechanical display, the reel needs to be moved from its current stop position (from the previous game) to the new stop position.) The reels are stopped in a defined order, in the embodiment, left to right such that part of the game outcome is displayed before all of the reels are stopped such that the player can see what potential winning combinations exist as the various reels stop and whether those winning combinations transpire once all the reels are stopped.

In the embodiment, there is a normal or default output of the game outcome defined in output data 642, In the normal output the reels are displayed as spinning to a stop in a defined manner (e.g. spun at a certain speed or within a certain time) with defined accompanying sounds. Persons skilled in the art will appreciate that there may be some variation in the normal speed or duration of spinning, for example, within a normal range (in particular if mechanical reels are used).

Upon the condition determiner 624A of output controller 624 determining that an output condition (stored as condition data 643) has been met, the output selector 624B selects from at least two outputs of the game outcome in output data 642 in accordance with probabilities assigned to those outputs. In the embodiment, the output selection condition is that a subset of the plurality of reels, each of which will be spun to a stop prior to at least one other reel of the plurality of reels, includes at least part of a designated winning symbol combination. In one example, the output selection condition is that the first two reels of five reels include a scatter symbol and three or more scatter symbols form a winning symbol combination. The reels are displayed as stopping left to right and hence the two reels in this example are the two left most reels.

In the embodiment, the outputs which can be selected are different to the normal output but in other embodiments, one of the outputs could be the normal output. In the embodiment, each of the outputs is a modification to the normal output but persons skilled in the art will appreciate that the outputs could be alternatives rather than modifications. In one example, there are three different outputs to the normal output, a first which involves a modified sound output in the form of an additional sound, a second which involves the additional sound and an extended spin of the reels and a third which involves the additional sound and an extra-extended spin of the reels.

Once the output is determined, the output controller 624 ensures that the correct output is provided by providing the data either representing the output of the game outcome of enabling the generation of the output to the display controller 625 (which incorporates an appropriate display driver) which controls display 54 to display the game outcome in accordance with the selected output. Concurrently, the relevant sounds for the selected output are provided to speaker controller 626 (which includes an appropriate sound driver) which controls speaker 58 to output the relevant sounds.

In addition to the above, the outcome evaluator 623 evaluates the selected symbols based on prize table 644 and updates meters 645 as necessary. Outcome evaluator 623 may also trigger a feature game if one of the awards for the game outcome is the award of a feature game.

As indicated above, an outcome selection condition may be based on a predetermined game outcome being possible after one or more reels are spun to a stop position. The game outcome may be an entry in a pay table for the game or may be a value derived from the pay table such as a prize threshold. The number of reels that are required to have reached the stop position may form part of the suspense condition. For example, one outcome selection condition may be invoked in relation to a “wild” symbol that can be substituted for any other symbol. In this case even after a first reel is spun to a stop position, if a wild symbol corresponds to a win line, at that point in the game, it will appear to the player that they have a higher likelihood of winning a prize and accordingly it may be appropriate to determine that an outcome selection condition has been met. In contrast, if a prize is awarded for five symbols of the same type, it may be appropriate to trigger an outcome selection condition after two or three symbols of the same type have been spun to a stop.

An outcome selection condition may be based on the predetermined game outcome being that a prize is above a particular threshold value. For example, the condition determiner 624A may determine a number of possible game outcomes in the pay table appear possible after three of the reels have spun to a stop and based on the associated prizes determine whether any of the prizes are above a preset threshold.

An outcome selection condition may be based on a combination of two or more factors, for example the size of the prize corresponding to the outcome that appears possible and how likely it appears after a reel has spun to a stop that the player will win the prize; that is, based on the probability of the outcome occurring.

By way of specific example, in one game a prize may be awarded for five aces and may be the maximum prize for that game. A lesser prize may be awarded for four aces. An outcome selection condition may be set in relation to the five ace prize, so that if the first three reels each have aces on a win line the outcome selection condition is met. That is, the five ace prize appears to be possible after three reels and is judged to be sufficiently likely once the first three reels have aces. If the first three reels are two aces and a king the outcome selection condition is not met but an outcome condition is met if three of the first four reels are aces because it is not until the fourth reel that it is deemed that it will appear sufficiently likely that they will win the four ace prize. In this example, for a higher prize a relatively lower likelihood is sufficient to meet the outcome selection condition.

The above suspense conditions relate to a symbol combination on a single win line, however the suspense condition may based on multiple win lines or derived based on different ways to win of a “Reel Power” game. For example, in one embodiment the outcome selection condition may only be met if a game outcome from the pay table appears possible in relation to two or more win lines played by a player. That is, a subset of all winning outcomes specified in the pay table may be sufficient to meet the outcome selection condition if two or more such winning outcomes appear possible for different win lines.

Alternatively, it may be required that the total of the win outcomes that appear possible across all win lines played by the player exceed a prize threshold such that possible outcomes from separate wins can contribute to that total. That is, apparent game outcomes with prizes below the threshold on an individual win line will not the meet the outcome selection condition but if the total of prizes that appear possible after a certain number of reels exceeds the threshold the suspense mode may be entered into. Different thresholds may be set for different numbers of reels having spun to a stop and/or different numbers of win lines.

As discussed above, the output of the game outcome may be adjusted by altering the duration of the spinning of one or more reels. For example, if two aces appear on the first reel and second reels, the duration of spinning of the third reel may be extended.

Alternatively, the speed of spinning or a reel may be adjusted. For example, if aces appear on the first four reels, the duration of the spinning of the fifth reel may be the same but the speed of the spinning of the fifth reel may be slowed so that the player can more readily perceive the symbols on the reel as they move into position or sped up as an indicator of excitement.

Another possible output is to reverse the direction of spinning of the reel.

It is possible to combine variations of spinning. For example, both duration and speed may be altered.

In some embodiments, an eligibility criteria may be applied, for example that the player has made a certain sized wager, made an ante bet, selected all win lines, played sufficient games, or the player is a member of a loyalty program.

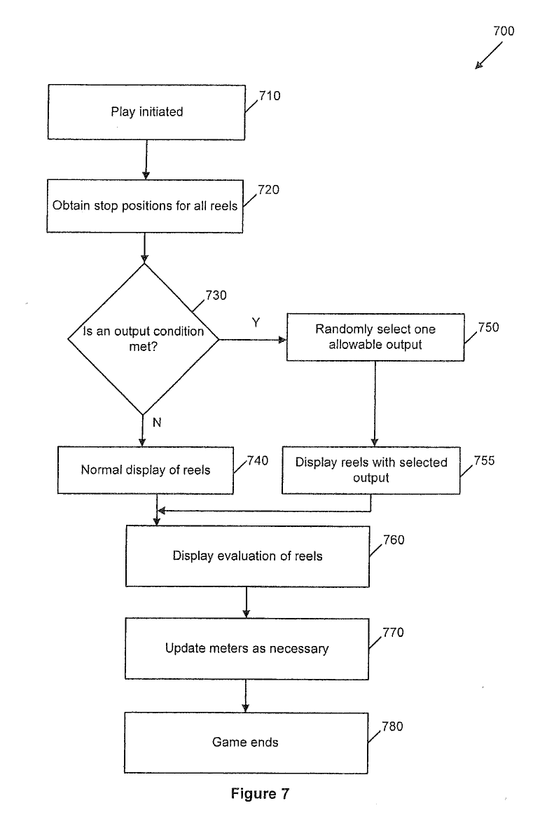

The method 700 of an embodiment is shown in FIG. 7. Play is initiated at step 710 which results in the game controller obtaining 720 stop positions for the reels. The gaming system determines 730 whether an output selection condition is met. If no output selection condition is met, there is a normal display of reels 740. If an output selection condition is met there is a random selection 750 of one of the outputs based on the assigned probabilities and the reels are displayed with the selected outputs 755. In addition, the evaluation of the reels 760 is also displayed to the player and the meters are updated as necessary 770 and the game ends 780. A person skilled in the art will appreciate that if the game includes a feature game, this will be carried out subsequent to evaluation of the reels and itself will be evaluated.

Further aspects of the method will be apparent from the above description of the system. It will be appreciated that at least part of the method will be implemented electronically, for example digitally by a processor. Persons skilled in the art will also appreciate that the method could be embodied in program code. The program code could be supplied in a number of ways, for example on a tangible computer readable storage medium, such as a disc or a memory (for example, that could replace part of memory 103) or as a data signal (for example, by transmitting it from a server). Persons skilled in the art, will appreciate that program code provides a series of instructions executable by the processor.

### Example

In the example, a game is provided where three or more scatter symbols trigger the feature. A scatter symbol is a symbol which participates in a winning combination irrespective of its position relative to a win line selected by the player. That is, it can appear at any place on a reel and be counted. In the example, the output selection condition is that scatter symbols appear on the first two reels. That is, there is a potential trigger situation. In the example, the player is awarded different numbers of free games in the feature depending on whether the player spins up 3, 4 or 5 scatters.

It will be appreciated that this involves an assessment of a subset of the reels to determine whether there is a potential winning combination. In the embodiments, the third reel can spin in three different ways:

1. a usual reel spin with an addition sound;

2. a faster extended reel spin with an addition sound; and

3. a faster extra extended reels spin with sound.

The probabilities assigned to these three different outputs are summarised in Table 1.

TABLE 1

| | Proba- | | Probability of | |
|---|---|---|---|---|
| | bility | Probability of | output type | |
| | of | output type | from for | |
| | success | for scatters | scatters on | Total |
| | once | on first two | first two reels | probability |
| | pre-trigger | reels and | but not third | of |
| Output Type | occurs | third reel | reel | output type |
| 1. normal + | 0.1 | 0.1 | 0.8 | 0.73 |
| sound | | | | |
| 2. extended | | 0.65 | 0.2 | 0.245 |
| spin + sound | | | | |
| 3. extra | | 0.25 | 0 | 0.025 |
| extended | | | | |
| spin + | | | | |
| sound | | | | |

From Table 1 it will be apparent that different probabilities are assigned depending on whether a scatter symbol will land on the third reel.

In the example, if the third reel spins with an extra extended spin with sound, the feature is guaranteed to be triggered as this type of spin only occurs when a scatter symbol appears on the third reel. If the third reel spins with a faster extended reel spin (not an extra extended reel spin), the player has a good chance of triggering a feature. If the reel spins with just the additional sound, the player is relatively unlikely to trigger the feature.

If the potential trigger happens one in ten games, and one in ten of these are successful, this means that most potential triggers are quick and “painless” in the sense that there is no big build up or an increase in anticipation when the feature is unlikely to be triggered. About one in four potential triggers have a big build up (a longer the reel spin). A player should get excited when this happens as they have a good chance of triggering the feature.

From this example, it will be appreciated that the probabilities assigned to particular outputs can also be controlled. In the above example, the probability is controlled based on whether the player has part of a trigger or the trigger for the minimum number of free games. It will be appreciated that in other embodiments, there could be multiple output selection conditions with different probabilities assigned to different output conditions or having a first part of a winning combination may provide first probabilities, having a second part of a winning combination may provide second probabilities; and having both parts may provide third probabilities.

It will be understood to persons skilled in the art of the invention that many modifications may be made without departing from the spirit and scope of the invention, in particular it will be apparent that certain features of embodiments of the invention can be employed to form further embodiments.

For example, it will be appreciated that the above description is of a gaming system with a video display. Gaming systems for implementing games that involve a display of spinning reels can have either a video display of a virtual reel or a mechanical display, these later machines most usually being “stepper” machines which have a separate motor for each reel whose stop positions can be selected in an analogous manner to that described above in respect of a video display.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of controlling output of a game outcome to a player in a gaming system:
obtaining a stop position for each of a plurality of reels, each reel having a plurality of symbols, each stop position specifying which symbols of the reel will be displayed to thereby specify a game outcome;
determining whether an output selection condition is met in respect of the specified game outcome;
randomly selecting from at least two different outputs of the specified game outcome based on probabilities associated with respective ones of the at least two different outputs upon the output selection condition being met;
outputting the specified game outcome in accordance with the selected output.

2. A method as claimed in claim 1, wherein determining that an output selection condition is met comprises determining whether the to be displayed symbols of a first subset of the plurality of reels, each of which will be spun to a stop prior to at least one other reel of the plurality of reels, include at least part of a designated winning symbol combination.

3. A method as claimed in claim 2, wherein there are a plurality of designated winning symbol combinations and the method comprises determining that the to be displayed symbols of a first subset include at least one of the designated winning symbol combinations.

4. A method as claimed in claim 3, wherein the plurality of designated winning symbol combinations are formed from different numbers of the same designated symbol.

5. A method as claimed in claim 4, comprising assigning first probabilities to the at least two different outputs upon the first subset including a first number of the designated symbol and assigning second probabilities to the at least two different outputs upon the first subset including a second number of the designated symbol winning combination.

6. A method as claimed in claim 2, comprising assigning first probabilities to the at least two different outputs upon the first subset including part of the designated winning symbol combination and assigning second probabilities to the at least two different outputs upon the first subset including all of the winning combination.

7. A method as claimed in claim 1, wherein there are a plurality of possible game outcomes and a subset of the game outcomes meet the output selection condition.

8. A method as claimed in claim 1, wherein each output includes at least one modification relative to the output of reels being spun to a stop when the output selection condition is not met.

9. A method as claimed in claim 8, wherein there are three different outputs corresponding to three different modifications and a first modification comprises an alternative sound, a second modification comprises an extended reel spin and an alternative sound, and a third modification comprises an extra-extended reel spin and an alternative sound.

10. A method as claimed in claim 9, wherein the third modification can only occur when the specified game outcome includes the player triggering a feature game.

11. A method as claimed in claim 1, wherein determining whether an output selection condition is met in respect of the specified game outcome is partly based on a wager placed by a player.

12. A gaming system comprising:
a stop determiner configured to determine a stop position of a each of a plurality of reels, each reel having a plurality of symbols, each stop position specifying which symbols of the reel will be displayed to thereby specify a game outcome;
a player interface for outputting the game outcome to a player and including a display for displaying spinning of each reel to the reel's stop position; and
an output controller arranged to:
determine whether an output selection condition is met in respect of the specified game outcome;
randomly select from at least two different outputs of the specified game outcome based on probabilities associated with respective ones of the at least two different outputs upon the output selection condition being met; and
control output of the specified game outcome with the player interface in accordance with the selected output.

13. A gaming system as claimed in claim 1, wherein the player interface includes at least one speaker, and one or more of the outputs includes sound for output with the at least one speaker.

14. A gaming system as claimed in claim 12, wherein the output controller determines that an output selection condition is met by determining whether the to be displayed symbols of a first subset of the plurality of reels, each of which will be spun to a stop prior to at least one other reel of the plurality of reels, include at least part of a designated winning symbol combination.

15. A gaming system as claimed in claim 14, wherein there are a plurality of designated winning symbol combinations and the output controller determines that the to be displayed symbols of a first subset include at least one of the designated winning symbol combinations.

16. A gaming system as claimed in claim 15, wherein the plurality of designated winning symbol combinations are formed from different numbers of the same designated symbol.

17. A gaming system as claimed in claim 16, wherein the output controller assigns first probabilities to the at least two different outputs upon the first subset including a first number of the designated symbol and assigns second probabilities to the at least two different outputs upon the first subset including a second number of the designated symbol winning combination.

18. A gaming system as claimed in claim 14, wherein the output controller assigns first probabilities to the at least two different outputs upon the first subset including part of the designated winning symbol combination and assigns second probabilities to the at least two different outputs upon the first subset including all of the winning combination.

19. A gaming system as claimed in claim 12, wherein there are a plurality of possible game outcomes and a subset of the game outcomes meet the output selection condition.

20. A gaming system as claimed in claim 12, wherein each output includes at least one modification relative to the output of reels being spun to a stop when the output selection condition is not met.

21. A gaming system as claimed in claim 20, wherein there are three different outputs corresponding to three different modifications and a first modification comprises an alternative sound, a second modification comprises an extended reel spin and an alternative sound, and a third modification comprises an extra-extended reel spin and an alternative sound.

22. A gaming system as claimed in claim 21, wherein the output controller is arranged such that the third modification can only occur when the specified game outcome includes the player triggering a feature game.

23. A gaming system as claimed in claim 12, wherein determining whether an output selection condition is met in respect of the specified game outcome is partly based on a wager placed by a player.

24. A game controller for a gaming system, the game controller arranged to:
determine a stop position of a each of a plurality of reels, each reel having a plurality of symbols, each stop position specifying which symbols of the reel will be displayed to thereby specify a game outcome;
determine whether an output selection condition is met in respect of the specified game outcome;
randomly select from at least two different outputs of the specified game outcome based on probabilities associated with respective ones of the at least two different outputs upon the output selection condition being met; and
control output of the specified game outcome in accordance with the selected output.

25. A game controller as claimed in claim 24, arranged to determine that an output selection condition is met by determining whether the to be displayed symbols of a first subset of the plurality of reels, each of which will be spun to a stop prior to at least one other reel of the plurality of reels, include at least part of a designated winning symbol combination.

26. A game controller as claimed in claim 25, wherein there are a plurality of designated winning symbol combinations and the game controller determines that the to be displayed symbols of a first subset include at least one of the designated winning symbol combinations.

27. A game controller as claimed in claim 26, wherein the plurality of designated winning symbol combinations are formed from different numbers of the same designated symbol.

28. A game controller as claimed in claim 27, arranged to assign first probabilities to the at least two different outputs upon the first subset including a first number of the designated symbol and assign second probabilities to the at least two different outputs upon the first subset including a second number of the designated symbol winning combination.

29. A game controller as claimed in claim 25, arranged to assign first probabilities to the at least two different outputs upon the first subset including part of the designated winning symbol combination and assign second probabilities to the at least two different outputs upon the first subset including all of the winning combination.

30. A game controller as claimed in claim 24, wherein there are a plurality of possible game outcomes and a subset of the game outcomes meet the output selection condition.

31. A game controller as claimed in claim 24, wherein each output includes at least one modification relative to the output of reels being spun to a stop when the output selection condition is not met.

32. A game controller as claimed in claim 31, wherein there are three different outputs corresponding to three different modifications and a first modification comprises an alternative sound, a second modification comprises an extended reel spin and an alternative sound, and a third modification comprises an extra-extended reel spin and an alternative sound.

33. A game controller as claimed in claim 32, arranged such that third modification can only occur when the specified game outcome includes the player triggering a feature game.

34. A game controller as claimed in claim 24, wherein determining whether an output selection condition is met in respect of the specified game outcome is partly based on a wager placed by a player.

35. A gaming system comprising:
a stop determiner configured to determine a stop position of a each of a plurality of reels, each reel having a plurality of symbols, each stop position specifying which symbols of the reel will be displayed to thereby specify a game outcome;
a player interface for outputting the game outcome to a player and including a display for displaying spinning of each reel to the reel's stop position; and
an output controller arranged to:
determine whether an output selection condition is met in respect of the specified game outcome;
randomly select from at least two different outputs of the specified game outcome based on probabilities associated with respective ones of the at least two different outputs upon the output selection condition being met; and
control output of the specified game outcome with the player interface in accordance with the selected output.

36. A gaming system comprising:
means for determining a stop position of a each of a plurality of reels, each reel having a plurality of symbols, each stop position specifying which symbols of the reel will be displayed to thereby specify a game outcome;
means for outputting the game outcome to a player and including a display for displaying spinning of each reel to the reel's stop position;
means for determining whether an output selection condition is met in respect of the specified game outcome;
means for randomly select from at least two different outputs of the specified game outcome based on probabilities associated with respective ones of the at least two different outputs upon the output selection condition being met; and
means for controlling output of the specified game outcome in accordance with the selected output.

37. A gaming machine comprising:
a cabinet;
a display mounted to the cabinet for displaying game outcomes to a player;
a speaker mounted to or within the cabinet;
at least one input device operable to initiate a play of a game; and
a game controller mounted within the cabinet and communicatively coupled to each of the display, the speaker and the at least one input device and operable responsive to operation of the at least one input device to conduct a play of a game in part by obtaining a stop position for each of a plurality of reels, each reel having a plurality of symbols, each stop position specifying which symbols of the reel will be displayed to thereby specify a game outcome, determining whether an output selection condition is met in respect of the specified game outcome, randomly selecting from at least two different outputs of the specified game outcome based on probabilities associated with respective ones of the at least two different outputs upon the output selection condition being met, and controlling the display and the speaker to output the specified game outcome in accordance with the selected output.

38. A method as claimed in claim 1, further comprising executing computer program code for obtaining, determining, randomly selecting, and outputting.

39. A method as claim in claim 38, further comprising storing said computer program code in a tangible computer readable medium.

40. A method as claim in claim 38, further comprising transmitting the computer program code.
